(19) United States
(12) Patent Application Publication
(10) Pub. No.: US 2002/0082991 A1
(43) Pub. Date: Jun. 27, 2002

(54) Telecommunications cost management system

(76) Inventors: Richard Friedman, San Francisco, CA (US); Scott Mosher, Monte Sereno, CA (US); Roy E. Helander, Laguna Beach, CA (US)

Correspondence Address: Mitchell S. Rosenfeld, Esq., c/o Law Offices of Gregory Scott Smith, Suite 317, 3900 Newpark Mall Road, Newark, CA, 94560, US

(21) Appl. No.: 09/750,494

(22) Filed: Dec. 27, 2000

(51) Int. Cl. G06F 17/60

(52) U.S. Cl. 705/40

(57) ABSTRACT

The present invention is a data processing system and method for analyzing billing indices regarding billed telecommunications items. The system includes a data input mechanism for receiving the telecommunications bills; a database of pre-determined billing indices; a processor configured to compare the billed indices from the telecommunications bill against of the pre-determined indices, identify billing discrepancies, and generate deprovision requests and billing disputes based upon the billing discrepancies; and data output mechanisms for transmitting the deprovision requests and the billing disputes. The system and method also determines and corrects errors in the database of pre-determined billing indices, and identifies and accrues installed telecommunication components that are not included as the billed telecommunication items.

### FIELD OF THE INVENTION

The present invention relates generally to telecommunications cost management systems and more particularly to an automated reconciliation, payment and accounting system for use by large-scale telecommunications consumers for auditing and managing bills from their telecommunications vendors.

### BACKGROUND OF THE INVENTION

The telecommunications industry is rife with over billing and misbilling problems. Deregulation has created a virtual electronic jungle of different carriers, service providers and other billing intermediaries. This complex multi-level service structure carries with it a complex multi-level billing structure. This complexity combined with millions of connections and charging events that are created monthly results in large, confusing bills for large-scale telecommunications consumers. Thus, it is unduly burdensome and impractical to use traditional hands-on manpower normally associated with any type of billing audit (i.e., manually going through monthly billing statements). As a result, a limited resource (time) is spent summarizing costs and paying bills rather than identifying cost-improvement opportunities and ensuring the correctness of a bill for all vendors.

Also, telecommunications service providers (Telco's) make significant errors in creating bills for end users, with the industry-standard error rates approaching approximately 5% of the total billings. As stated however, errors are difficult to find in a stack of bills, particularly given back billing and various tariff changes. Circuit and cost tracking, error detection, bill payment, and expense posting to a general ledger all involve manual processes, boxes of paper, and significant manpower.

### SUMMARY OF THE INVENTION

The invention relates specifically to an automated reconciliation, payment and accounting system for use by large-scale telecommunications consumers to audit and manage bills from their telecommunications vendors. The system of the present invention manages and analyzes telecommunications bills input in a variety of formats, including paper and numerous electronic formats. The system then normalizes these varied formats and performs several analyses, which allow for the creation of relevant reports for accounting and auditing purposes.

The present invention includes, briefly, a data processing system and method for analyzing billing indices regarding billed telecommunications items. The system includes a data input mechanism for receiving the telecommunications bills; a database of pre-determined billing indices; a processor configured to compare the billed indices from the telecommunications bill against of the pre-determined indices, identify billing discrepancies, and generate deprovision requests and billing disputes based upon the billing discrepancies; and data output mechanisms for transmitting the deprovision requests and the billing disputes. The system and method also determines and corrects errors in the database of pre-determined billing indices, and identifies and accrues installed telecommunication components that are not included as the billed telecommunication items. The present invention has other objects and advantages which are set forth in the description of the Best Mode of Carrying Out the Invention. The features and advantages described in the specification, however, are not all inclusive, and particularly, many additional features and advantages will be apparent to one of ordinary skill in the art in view of the drawings, specification, and claims herein.

### BRIEF DESCRIPTION OF THE DRAWINGS

FIGS. 1 through 8 of the drawings depict a version of the preferred embodiment of the present invention for the purpose of illustration only. One skilled in the art will readily recognize from the following discussion that alternative embodiments of the structures and methods illustrated herein may be employed without departing from the principals of the invention described herein.

FIG. 1 is a block diagram depicting the overall logic of the system of the present invention and the general flow of information within the system.

FIG. 2 is a block diagram of the structural components of the present invention.

FIG. 3 is a flow chart showing the bill reconciliation process flow.

FIG. 4 is a flow chart showing the electronic bill loading process flow.

FIG. 5 is a flow chart showing the manual bill loading process flow.

FIG. 6 is a flow chart showing the OSS extract loading process flow.

FIG. 7 is a flow chart showing the preparation of invoices and transmission to ANP process flow.

FIG. 8 is a flow chart showing the accruals process flow.

FIG. 9 shows a block diagram of the GUI hierarchy of the system of the present invention.

FIG. 10 shows an exemplary universal dispute form.

FIG. 11 shows an exemplary deprovision request spreadsheet.

FIG. 12 shows an exemplary general ledger extract for accruals.

FIGS. 13a and 13b show an exemplary accounts payable extract and voucher, respectively.

With respect to the process flow figures, squares represent manual processes, hexagons represent system processes, diamonds represent decision points, circles represent on-page connectors, round edged rectangles represent process ends, truncated rectangles represent reports, and pentagons represent off-page connectors.

### DETAILED DESCRIPTION OF THE PREFERRED EMBODIMENTS

Overview

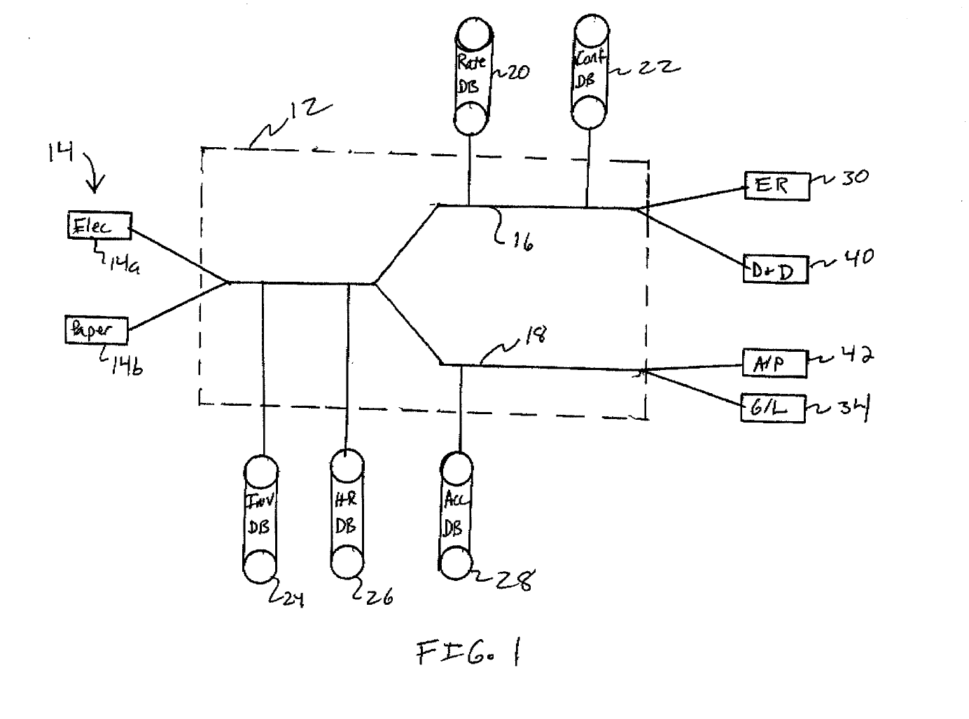

FIG. 1 shows the overall structure of the system of the present invention and the general flow of information within the system.

System 10 includes compiled software for carrying out all of the automated processes of system 10. Bills 14 (electronic 14a and paper 14b) are input to system 10 where upon the information from bills 14 is processed by either bill verification procedures 16 or accounting procedures 18 of system processes 12. Telecommunication bills typically contain billing items pertaining to particular components (e.g., circuits, pagers, cellular phones, DSL lines, twisted pair telephone lines, and any other potential telecommunication service or device), the rate charged for the particular components and the quantity of the particular components. System 10 also includes a rate database 20 for storing billing rate information and configuration/USOC database 22 for storing configuration information. Rate database 20 and configuration/USOC database 22 may reside on either the same or separate data storage devices that are either integrated with or separate from the system server. USOC is the acronym for Universal Service Order Code, which is a standardized descriptor, established by Telcordia and used by most Telco's, to identify the components of telecom services that are being billed.

System 10 also includes the telecommunication consumer's corporate telecommunication inventory database 24, human resources database 26 and corporate chart of accounts database 28, so that system processes 12 have access to important consumer information, such as product orders, service orders, and employee status, indicative of the existence and usage of telecommunication components. For example, these existence and usage databases indicate whether a circuit that has been billed has actually been installed or whether a cell phone that has been billed belongs to an employee that in no longer employed by the consumer.

Information from bills 14 as well as the various databases allow bill verification process 16 of system 10 to generate exception reports 30 relating to existence of billed products and services, rates charged, timing for the delivery of products and services, configurations, mileage, and usage; and to generate disputes and deprovisioning 32 through an automated dispute and deprovisioning management process. The same information is also used by accounting process 18 of system 10 for generating account payable extracts 34 for payment processing and general ledger extracts 36 for expenses, capital and accruals.

System 10 includes a variety of interrelated processes including bill reconciliation, accrual preparation, data management and management reporting processes, all of which are supported by specific procedures which are described in detail in the System Operation section below. The bill reconciliation process yields exception reports 30, disputes and deprovisions 40, and invoices for accounts payable 42. The accrual process results in the loading of general ledger extracts 34 for accruals into the consumer's corporate accounting system. The management reporting processes provide reports regarding bill tracking, trends, expenses, disputes, inventory reconciliation and processing statistics for use in the bill reconciliation, accrual and data management processes. The data table maintenance processes allow maintenance of the tables for archiving, tariff and contract rates, accounting codes and USOC logic sets.

Consumers utilize these processes of system 10 via a graphical user interface (GUI). The configuration, navigation and operation of system 10 with respect to GUI 44, and in particular the specific system procedures accessed by consumers via GUI 44, are described in detail in the System Operation section below. Preceding that section are more detailed discussions of the system processes.

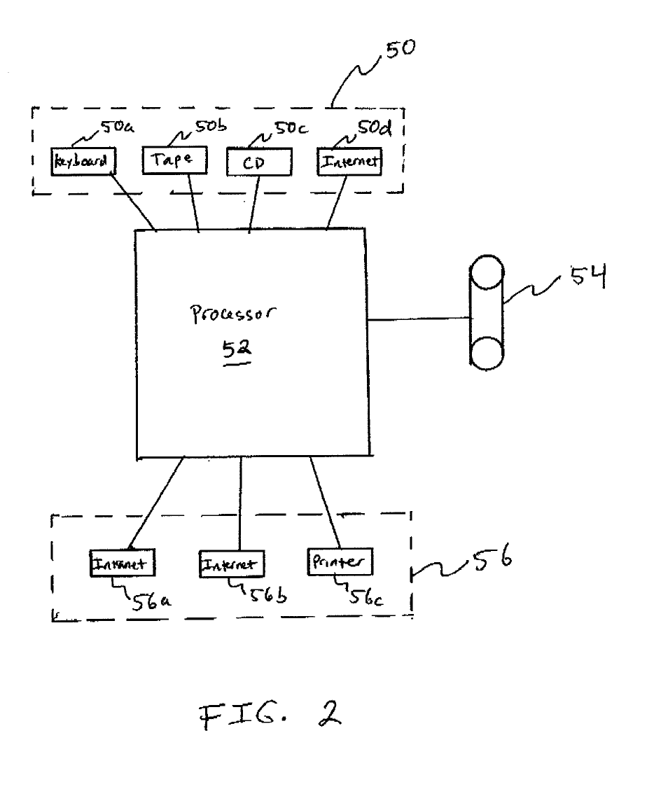

The components of system 10 are depicted in FIG. 2. System 10 includes data input mechanisms 50, processor mechanism 52, storage device(s) 54 and output mechanisms 56. Data input mechanisms 50 include any available data input means such as manual entry via keyboard 50a, electronic loading via CD-Rom drive 50c or tape drive 50b, or electronic loading via the Internet 50d.

Processor mechanism 52 is a commercially available general purpose computer having a commercially available CPU that is specially configured via unique software for carrying out the specific processes of system 10 such as extracting billing data, identifying non-existent billing item components, determining and correcting errors in the consumers database, determining errors in billing item rates, determining errors in billing item quantities, and generating billing item disputes. The software is a distributed client/server-based application, which operates on generic platforms such as UNIX, Windows 95 and Windows NT and use non-proprietary languages such as PowerBuilder Powerscript, C++, SQL, and PL-SQL. It can be deployed in various methods including stand-alone deployment on a windows based PC system; shared via WAN or LAN or distributed client/server application. The software can be easily integrated with other open-systems based applications and it incorporates Windows 95/Window NT graphical user interfaces (GUI's).

Storage devices 54 include one or more commercially available hard drives, hard drive arrays, optical disk drives, tape drives or other storage means configured for the databases 20, 22, 24, 26, 28 of system 10. Output mechanisms 56 include any available data output means such as the consumer's corporate intranet 56a for internal electronic delivery to the consumer's accounting and financial management systems, the Internet 56b for external electronic delivery to vendors, and printer 56c for manual delivery to both the consumer's internal departments and to vendors.

System Processes

### BILL RECONCILIATION

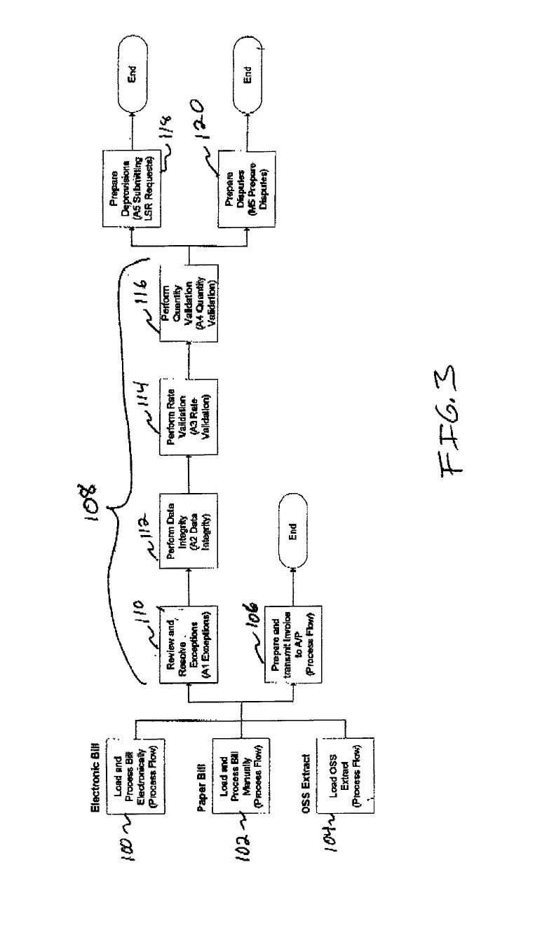

Turning to FIG. 3 the overall bill reconciliation process flow of the preferred embodiment is shown. Generally, bill reconciliation involves data input, analysis and reporting. In order to initiate the billing reconciliation process, first billing data must be input to system 10. Depending on the format of the bills and related information, data can be entered in several methods both electronically 100 and manually 102. Additionally, OSS (“Operations Support Systems) data, reflecting the customer's internal records with respect to telecommunications purchases, are loaded 104 into system 10. The data input to system 10 is then used to prepare and transmit consolidated invoices to accounts payable 106 and analyze the billing data 108.

Analyzing the billing data consists of a four-step process: exceptions analysis 110, data integrity analysis 112, rate validation analysis 114, and quantity validation analysis 116. The four-step process allows the preparation of deprovisions 118 and disputes 120.

Exception analysis 110 generates an exception report that targets immediate discrepancies, which can be tagged, flagged and identified with reasonable precision without resorting to detailed analysis. This identifies invalid circuits, circuits with incorrect service dates, and unusual installation charges. Then, data integrity analysis 112 is performed to validate the consumer's own data. Next, rate analysis 114 is performed based upon usage and the Universal Service Order Code (“USOC”). Finally, a quantity analysis 116 is performed, which identifies usage, mileage, and configuration discrepancies.

The bill reconciliation process can be broken into a number of sub-processes: data input (electronic bills 100, paper bills 102, OSS extracts 104); analyses (exceptions 110, data integrity 112, rate validation 114 and quantity validation 116); and information preparation (invoices 106, deprovisions 118 and disputes 120). Each of these is addressed in more detail below:

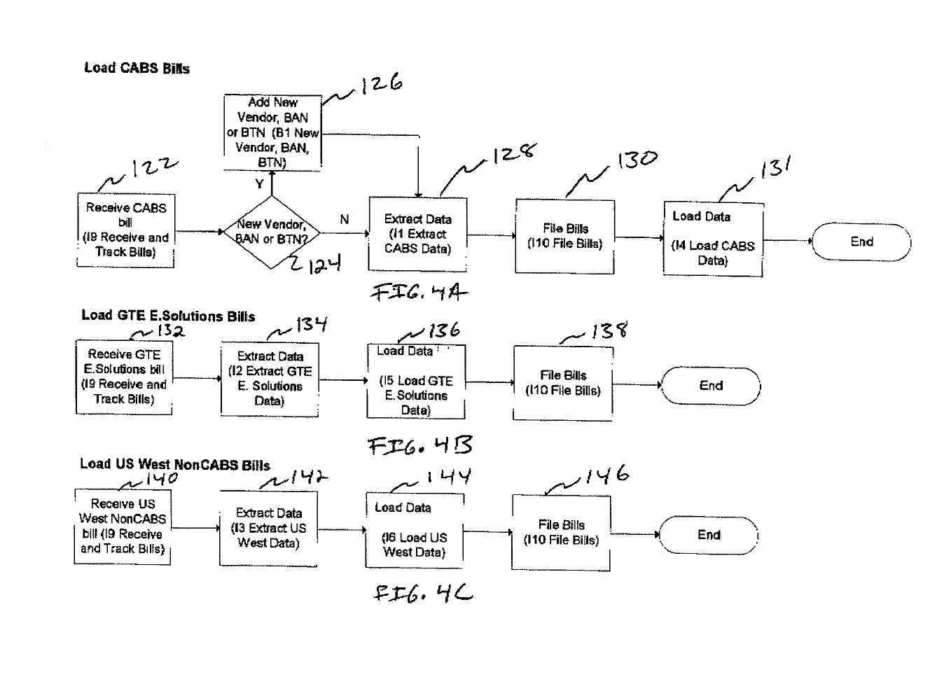

Electronic Bills: Referring now to FIGS. 4a-c, shown in detail are the electronic bill loading process flows. Vendors (e.g., Telco's) provide bills for wholesale services in a number of different formats, which fall into one of two categories: CABS (carrier access bills) and non-CABS (such as GTE E. Solutions and US West Bill Mate).

As depicted in FIG. 4a, CABS bills are first received and tracked 122 in accordance with procedure 19. System 10 then determines whether the bill references a new vendor, BAN or BTN 124. If there is a new vendor, BAN or BTN, procedure B1 is performed 126 to add the new vendor, BAN or BTN. Once the new vendor, BAN or BTN is added or if there was not a new one, the CABS data is extracted 128 in accordance with procedure 11. Then, bills are manually filed 130 and the data is loaded 131 in accordance with procedure 14.

Non-CABS bills are loaded utilizing a similar process. With respect to GTE E. Solutions bills, as shown in FIG. 4b, the bills are received and tracked 132 utilizing procedure 19, the data is extracted 134 utilizing procedure I2, the extracted data is loaded 136 utilizing procedure 15, and the paper bills are physically filed 138. With respect to US West Bill Mate bills, as shown in FIG. 4c, the bills are received and tracked 140 utilizing procedure I9, the data is extracted 142 utilizing procedure 13, the extracted data is loaded 144 utilizing procedure 16, and the bills are manually filed 146.

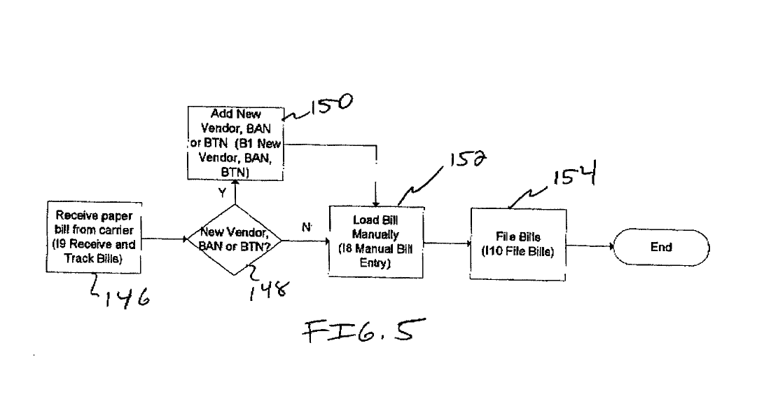

Paper Bills: Some vendors will only provide paper bills, which must be manually input to system 10. The manual bill loading process is depicted in FIG. 5. Paper bills are received and tracked 146 utilizing procedure I9. System 10 then determines whether the bill references a new vendor, BAN or BTN 148. If there is a new vendor, BAN or BTN, procedure B1 is performed 150 to add the new vendor, BAN or BTN. Once the new vendor, BAN or BTN is added or if there was not a new one, the bills are manually loaded 152 in accordance with procedure I8. Then, the bills are manually filed 154.

OSS Extracts:

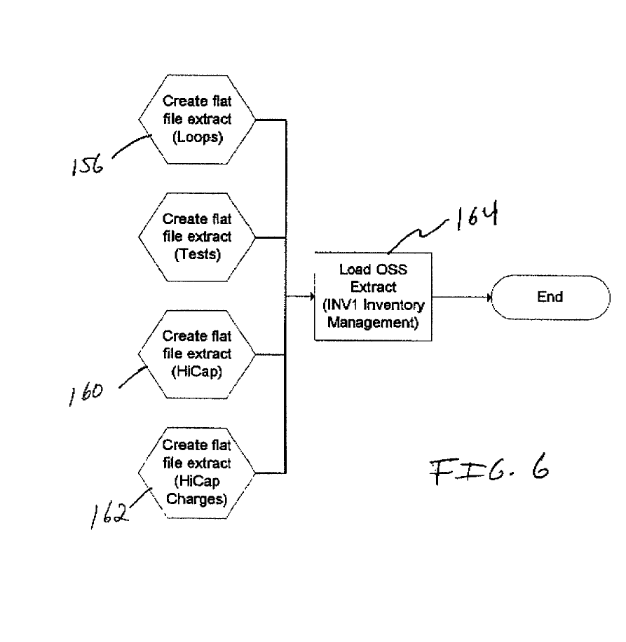

OSS extracts provide detailed information from the customers' internal systems and records that identify the type, quantity, timing, and configuration of telecom services that have been purchased. These data represent the control source that is compared to Telco bills. Depending on what type of services the customer purchases and how the customer maintains its records, there are several methods of loading this data into system 10. An example of one method of loading these data into system 10 is showed herein. As depicted in FIG. 6, this approach utilizes flat file or text file extracts for loop circuits 156, high capacity circuits 160, and estimated charges for high capacity circuits 162. These flat/text files are loaded 164 using procedure INV1 for inventory management.

Exception Analysis: Utilizing procedure A1, exception analysis 110 identifies three basic often-recurring problem areas: existence errors, service date errors, and installation charge anomalies. Circuits are tracked by system 10, which identifies if a circuit that has been disconnected, cancelled, or not yet delivered has been billed by the vendor. If such billing has occurred, then the circuit is flagged for dispute or deprovision. Similarly, if the circuit, pager, cell phone, or other telecom service was provisioned specifically for an employee of the customer who is no longer actively employed by the company, the item is flagged for deprovision. In addition, items for which charges for the incorrect time period are billed are flagged for dispute. As well, installation charges are detailed for review to identify anomalies that can be disputed.

Data Integrity Analysis: Existence exceptions are large in number and often appear as “not in inventory” (i.e., not in the consumer's records), which can mean that the consumers data is wrong. Therefore, data integrity analysis is performed to determine errors and provide feedback to the consumer to update their own records.

Rate Analysis: Rates are based upon two items, USOC components and usage. Thus, to determine the proper rate for a particular item (e.g., T1 line), the number of USOC or usage components is determined and total charges are divided by the number of USOC or usage components to derive an effective rate per component. This effective rate is compared to what should have been charged, which is set by either public tariffs or negotiated rates between the consumer and vendor. Where there are discrepancies between actual rates charged and those that should have been charged, the item is flagged for dispute. Rate analysis 114 is performed utilizing procedure A3.

Quantity Analysis: The quantity validation process is three-fold: usage analysis, mileage analysis, and configuration analysis. Usage analysis, utilizing procedure A4, examines the minutes used by site and by switch so that the minutes recorded at the consumer's switch can be compared to the minutes billed by the vendor. Mileage analysis is utilized for high-capacity circuits where charges are distance sensitive. The configuration analysis compares the ordered configuration with the billed configuration. The comparison is required given the manner in which items are ordered versus the manner in which they are billed. Consumers' engineers configure order items from vendors using engineering language such as channel termination, cross connect, and POT bay. However, vendors bill consumers based on USOC's by translating the engineering order into corresponding sets of USOC's. System 10 utilizes a unique conversion database 166 that maps engineering order items to USOC's by particular vendor and location. System 10 utilizes configuration database 22 to examine all engineering order items for a given circuit and selects those potentially applicable to a given type of consumer (e.g., wireless, ISP, bank). Then the applicable USOC's are compared to the billed USOC's to determine whether the billed USOC's are valid given the type of consumer. For example, a wireless provider will never order a circuit with two channel terminations; however, Telco's may mistakenly bill 2 of the USOC's that represent a channel termination to such a customer.

Deprovisions: Throughout the exception reports, rate analyses, and quantity analyses, items for deprovisioning are identified. As depicted in FIG. 3, deprovisions are prepared 118 utilizing procedure A5.

Disputes: Dispute management and tracking allows automated tracking and submission to vendors of disputable billing errors. Historical tracking allows for tracking of cash inflow from disputes, facilitates follow-up with vendors to enhance recoveries and generation of summary management reports. As depicted in FIG. 3, disputes are prepared 120 utilizing procedure M5.

Invoices: Process flow 116 for preparing invoices and transmission of invoices to A/P is depicted in FIG. 7. Preparation of an invoice for remittance 168 is carried out utilizing procedure R1. System 10 then determines whether a wire transfer is involved 170. If so, a wire transfer is prepared 172 utilizing procedure R2. Once the wire transfer is prepared or if no wire transferred is required, system 10 creates an A/P extract 174 and then loads the A/P extract into the consumers accounting database 176).

### ACCRUALS

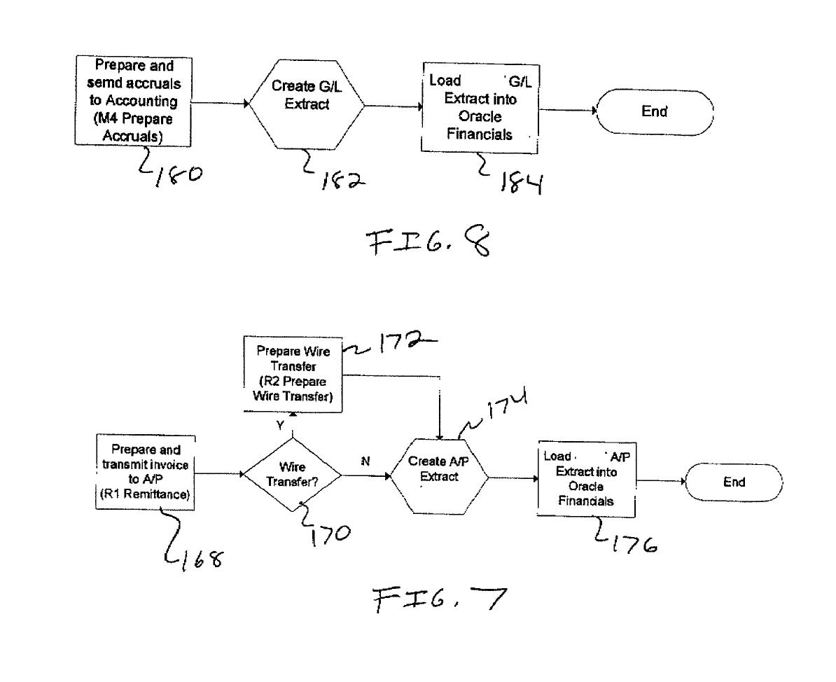

Accrual data is useful to consumers for financial forecasting purposes. Often orders are placed by consumers and delivered by vendors, but the vendors do not bill immediately. Additionally, billing may be delayed by untimely delivery of the order by the vendors. In order to effectively manage cash flow and estimate expenses, consumers must be able to track these accrued expenses. The accrual process of system 10 solves this problem. The accrual process flow is depicted in FIG. 8. Accruals are prepared and sent to accounting 180 utilizing procedure M4. System 10 then creates a G/L extract 182 and loads the G/L extract into the consumers accounting database 184 (or similar type of financial database).

### MANAGEMENT REPORTING

The management reporting processes provide reports regarding bill tracking, trending, expenses, disputes, inventory reconciliation and processing statistics for use in the bill reconciliation, accrual and data management processes, as well as for stand alone management reporting purposes of the consumer. System 10 includes a variety of specific management procedures M1-M10 that are described in detail in the System Operation section below.

### DATA TABLE MANAGEMENT

The data table maintenance processes allow maintenance of the tables for archiving, tariffs and contracts, accounting codes and USOC logic sets. These are the data tables that are utilized by the bill reconciliation, accrual and management reporting processes. System 10 includes a variety of specific data table maintenance procedures MNT1-MNT4 that are described in detail in the System Operation section below.

### SYSTEM OPERATION

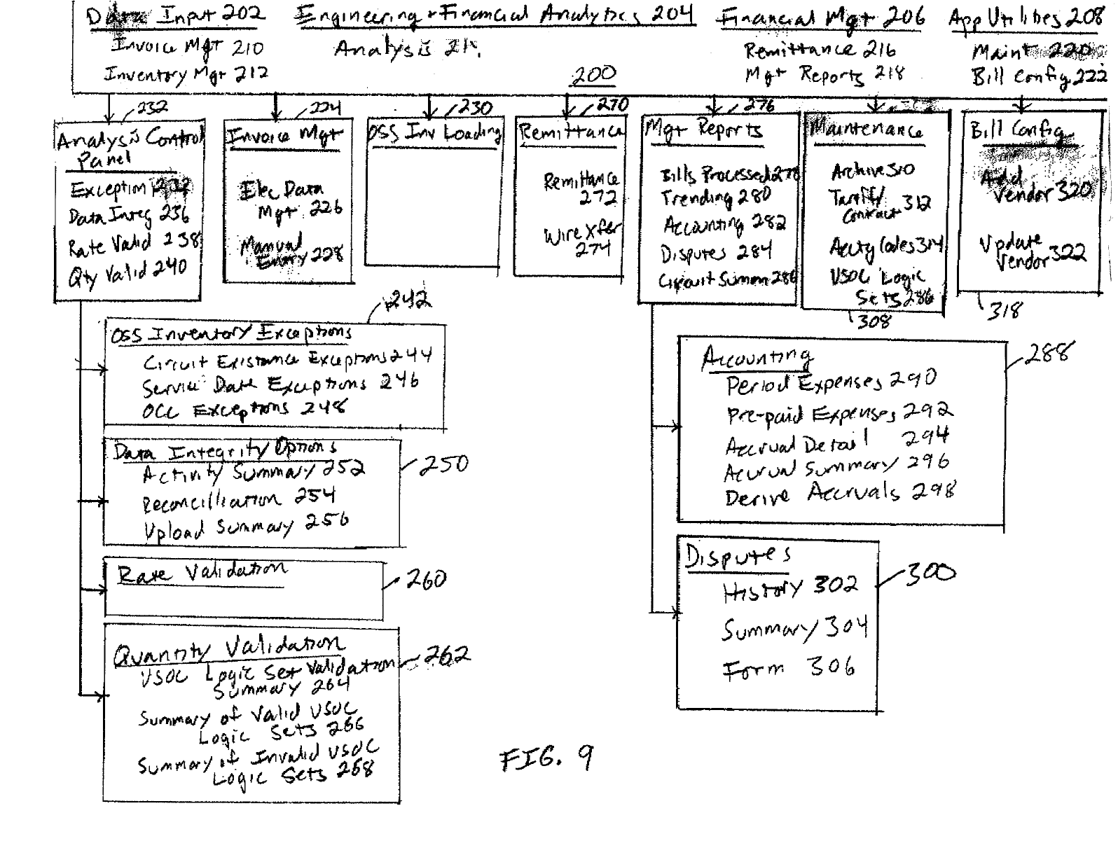

Consumers utilize the specific procedures of the above-described processes of system 10 via a graphical user interface (GUI). The configuration, navigation and operation of the GUI is depicted in FIG. 9 and described in detail below with respect to each of the system procedures. The GUI structure depicted in FIG. 8 is the preferred structure but only one of many possible GUI implementations of the process flows depicted in FIGS. 3-8.

Main menu 200 of system 10 is depicted in FIG. 9 and provides access to all menus and screens of GUI 44. Main menu 200 is divided into four functional sections: Data Input 202, Engineering and Financial Analytics 204; Financial Management 206 and Application Utilities 208. These sections lead to submenus that provide access to the other screens and menus. Data Input 202 is divided into Invoice Management 210 for carrying out procedures I1 through I9 and Inventory Management 212 for carrying out procedure INV1. Engineering and Financial Analytics 204 has Analysis 214, which leads to submenus for carrying out procedures A1 through A5. Financial Management 206 is divided into Remittance 216 for carrying out procedures R1 and R2 and Management Reports 218 for carrying out procedures M1 through M10. Application Utilities 208 is divided into Maintenance 220 for carrying out procedures MNT1 through MNT4 and Bill Configuration 222 for carrying out procedures B1 and B2.

### INVENTORY MANAGEMENT

Selecting invoice management 210 from main menu 200 leads to inventory management menu 224 from which procedures I4 through I9 are executed. Procedures I1-3 are carried out via commercially available applications.

Extracting CABS Data I1: This procedure allows for the extraction of CABS from 9 track tapes into the program for reconciliation and processing. The consumer receives 9 track tapes with CABS data. The tape is labeled with the vendor name and the bill cycle date if the bill cycle date is identified. The tape is loaded into the tape loader reader machine and utilizes a tape reader application to extract the data. The preferred embodiment utilizes a commercially available tape reader application known as OutRight, although any suitable tape reader application may be used. The OutRight tape reader application utilizes Windows based GUI's separate from GUI 44 of system 10.

Extract GTE E.Solutions Data I2: The purpose of this procedure is to extract GTE E.Solutions data into system 10 for reconciliation and processing. This procedure is mandatory for all GTE E.Solutions bills. It must be completed before procedure Load GTE E Solutions Data I5. The loading application provided by GTE is run using Windows outside of GUI 44 to extract the GTE data.

Extract US West Non-CABs Data I3: The purpose of this procedure is to extract US West Non-CABs data from the monthly US West CD into CCAT for reconciliation and processing. This procedure is mandatory for all US West bills received on a CD. It must be completed before I6 Load US West Data. The loading application provided by US West is run using Windows outside of GUI 44 to extract the US West data.

Loading Cabs Data I4: Load GTE E.Solutions Data I5: Load US West Data I6: This procedure allows a user to load CABS data extracted from a 9 track tape into system 10 for reconciliation and processing. Utilizing GUI 44 the data files for the CABS data, GTE data and US West data extracted from CD, tape or other media are loaded into system 10.

Defining Undefined Invoices I7: The purpose of this procedure is to verify that electronic bills (e-bills) are loaded correctly and to accept or reject items that were not loaded. This procedure is accessed by electronic data management dashboard 226 and is utilized during the execution of other procedures in the event undefined invoices are present in system 10 to define items such as the correct vendor and bill type. Once corrected, system 10 automatically updates the appropriate bill configuration information for each invoice.

Manual Bill Entry I8: The purpose of this section is to manually enter a paper bill into the program for reconciliation and processing. Manual entry screen 228 is utilized to manually enter via drop down menus when possible data such as vendor and circuit identity.

Receive and Track Bills I9: This procedure allows for the receiving and tracking of paper and electronic bills from vendors. This procedure is mandatory for all bills.

For each new paper bill, the receipt of the bill is logged in a bill tracking spreadsheet with information such as the date on which the paper bill was received, the users two letter initials, the total amount due, the number of circuits from the bill, and the two letter initials of the bill verification specialist who will process the bill. Electronic bills are also logged in a spreadsheet with additional information such as the vendor's tape/CD reference number.

### INVENTORY MANAGEMENT

Selecting inventory management 212 leads to OSS inventory loading screen 230 from which procedure INV1 is executed.

Inventory Management INV1: This procedure extracts and loads OSS inventory into system 10 to facilitate bill reconciliation and processing. This procedure ensures that the latest OSS inventory information is captured in the program.

### ANALYSIS

Selecting analysis 214 from main menu 200 leads to analysis control panel 232. From the Analysis Control Panel, access is provided to exception reports 234 for carrying out procedures A1 and A5, data integrity 236 for carrying out procedure A2, rate validation 238 for carrying out procedure A3 and quantity validation 240 for carrying out procedure A4.

Circuit Exceptions A1: By selecting exception reports 234, the OSS inventory exceptions menu 242 is accessed. This menu provides access to analysis of circuit existence exceptions 244, service date exceptions 246, and OCC exceptions 248. The circuit exceptions analysis displays a detailed listing of all circuits on a bill that do not match a circuit in inventory. This report is sorted by vendor, BAN (Billing Account Number), BTN (Billed Telephone Number) and Circuit ID. The service date exceptions analysis identifies exceptions where the Firm Order Confirmation (FOC) date in inventory is different from the FOC date on the bill. Since the report is only in reference to an initial billing, circuits only appear on this report the first time they are billed. This report allows a user to view and dispute charges, which may have been prematurely billed. The OCC exceptions analysis details the installation and pro-rated charges that appear in the Other Charges & Credits (OCC) section of the bill. Users can scroll to a desired vendor and BAN and review exceptions. The user can then research unexpected charges and decide which charges to dispute based on an internal billing reconciliation dispute policy. After calculating the amount in dispute, the user enters the disputed amount. The OCC exceptions analysis also summarizes installation and prorated charges by vendor. These exception analyses allow identification, review and resolution of exceptions between OSS inventory and bills processed through system 10. All items with a disputed amount are automatically captured on a universal dispute form.

Data Integrity A2: This procedure identifies, reviews and resolves OSS data entry differences identified after processing bills in system 10. This procedure is recommended for electronic bills. The procedure is executed from Analysis Control Panel 232 by selecting data integrity 236, which leads to data integrity option menu 250 which has three options: activity summary 252, reconciliation 254, and upload summary 256. First, activity summary 252 is selected which leads to active summary page 258 where the user finds the appropriate BAN and determine if there are integrity errors and whether system 10 has corrected the errors, confirms that the number of OSS corrections uploaded is the same as the number accepted. If these numbers are different, review the upload summary report via upload summary 256 on data integrity option menu 250.

To review system corrections and manually resolve integrity errors: select reconciliation 254 on the Data Integrity Option menu 250 which leads to the reconciliation screen, select the appropriate vendor and BAN from the drop down windows and review the system corrections to verify that they are correct or reasonable.

Also from the reconciliation screen to manually resolve integrity errors on a circuit by circuit basis: paper bills are researched to identify the PON or SON for the desired circuit, enter the PON or SON in the appropriate field for the circuit, and select Look-up to have system 10 try to match the entered PON or SON with a PON or SON in OSS.

To review differences in the OSS Corrections between uploaded and accepted circuits: select Upload Summary 256 on Data Integrity Option menu 250 which leads to the upload exception report screen, select the appropriate vendor and BAN from drop down windows, and research and fix the exceptions noted in the Upload Summary.

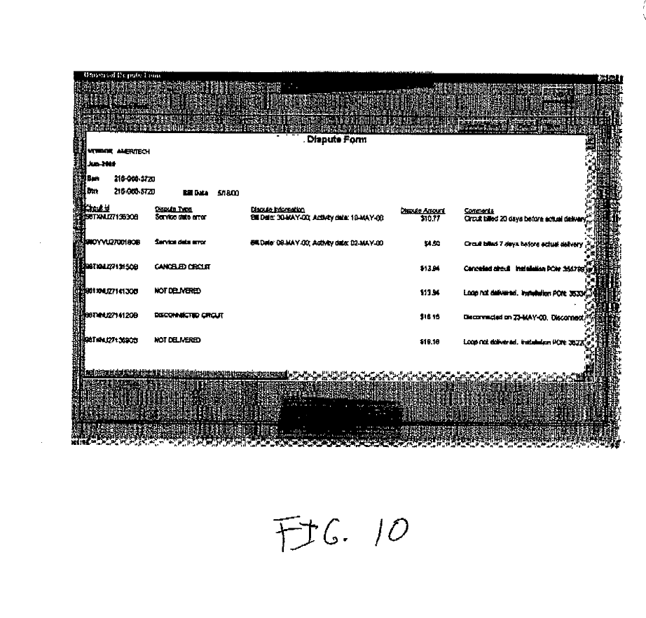

Rate Validation A3: This allows a user to identify differences between the billed rate and the agreed rate. To execute this procedure, rate validation 238 is selected from analysis control panel 232 to analyze usage and USOC rate variances. The analysis allows the user to determine which charge to dispute using an internal bill reconciliation dispute policy and the information displayed on rate validation screen 260 (accessed by selecting rate validation 236 from analysis control panel 232). Rate validation screen 260 displays information for particular billing items such as USOC code, USOC description, zone, state, billed rate, total rate and over-billed rate (i.e., what was billed versus what should have been billed based on a comparison carried out by system 10). Based on the billed and tariff contract rates displayed on the report the user can then determine the amount to dispute and enter the dispute amount. Any items with a disputed amount are captured on the Universal Dispute Form, an example of which is depicted in FIG. 10.

Quantity Validation A4: This analysis allows a user to understand circuits with correct and incorrect USOC logic sets and usage quantity exceptions. This procedure for quantity variance analysis is accessed via quantity validation 240 from analysis control panel 232. This leads to quantity validation screen 262 from which three analysis screens are accessed: USOC Logic Set Validation Summary 264, Summary of Valid USOC Logic Sets 266, and Summary of Invalid USOC Logic Sets 268. Logic Set Summary 266 summarizes quantities and charges for valid and invalid USOC logic sets by vendor. Based on the materiality of counts and charges for the invalid USOC, the user determines whether to review these configuration errors. Invalid logic sets 268 details circuits by vendor. The user then disputes material items that have configuration or USOC Logic set errors. The user then determines the amount to dispute Disputes are automatically saved to the Universal Dispute Form.

Submitting LSR Requests A5: This procedure deprovisions circuits for which a cancelled or disconnect order was not properly issued to the Telco. This procedure is mandatory for all circuits that need to be disconnected (deprovisioned).

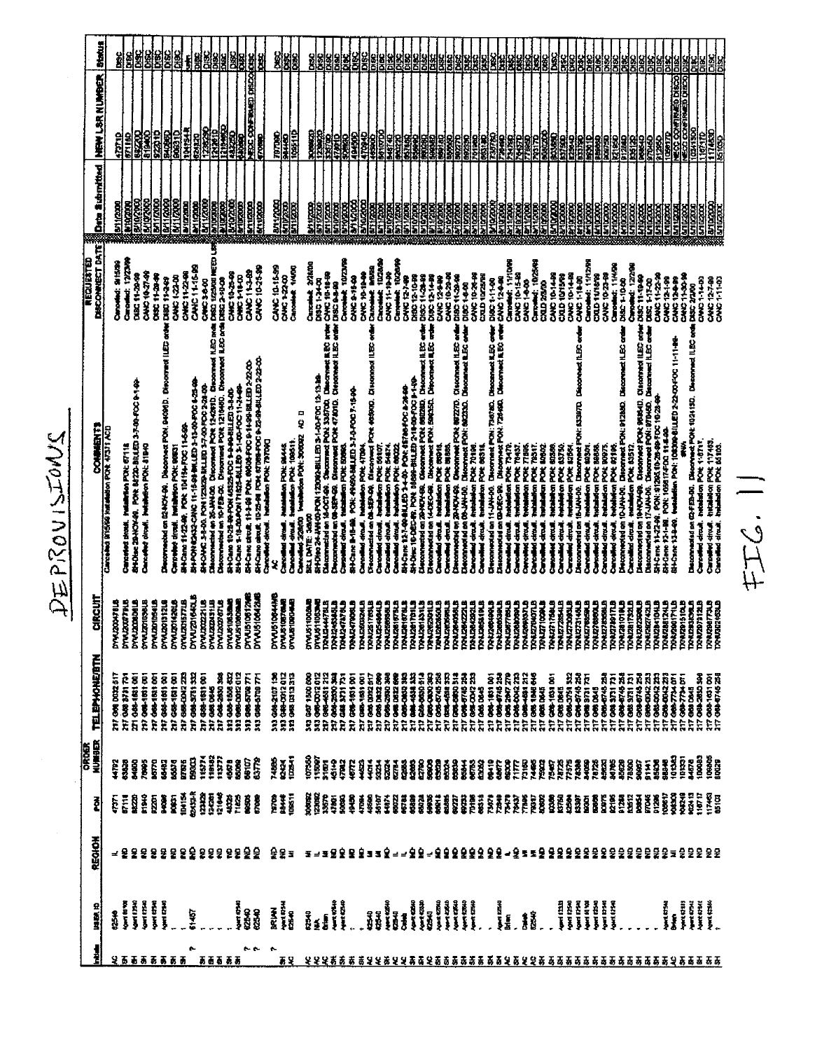

To execute this procedure, circuit exceptions 244 is selected from OSS inventory exception menu 242 where all vendors and BAN's are displayed. The disputed amount is changed to zero and the billing item is flagged for deprovisioning. The circuit disconnect orders are generated in a spreadsheet form for easy submission to vendors, an example of which is depicted in FIG. 11.

### REMITTANCE

Selecting Remittance 216 from Main menu 200 leads to remittance option menu 270 from which procedures R1 and R2 are executed.

Remittance R1: The purpose of this section is to prepare remittance vouchers to attach to paper bills for approval processing. To execute the procedure select remittance 272 from remittance option menu 270. Once bills have received approval, they are electronically transmitted to the system accounts payable interface for loading into the consumer's Oracle Financials. System 10 prints account vouchers, which are attached to the paper bill so that appropriate approvals at the consumer can be obtained. Once the bill is approved, the bill is sent by system 10 to accounts payable in the form of an extract file to be loaded into Oracle Financials.

Wire Transfers R2: This procedure prepares and processes wire transfer payments for bills. This procedure is mandatory for all wire transfer payments. To execute the procedure select wire transfer 274 from remittance option menu 270. The appropriate vendor is selected from a drop down menu. Upon user confirmation system 10 prints wire transfer forms for the vendor and accounts payable.

### MANAGEMENT REPORTS

Selecting Management Reports 218 from main menu 200 leads to management reports menu 276 from which procedures M1 through M10 are executed by selecting from a variety of options: bills processed 278, trending 280, accounting 282, disputes 284, and circuit summary 286.

Bill Tracking M1: The purpose of this procedure (accessed by selecting bills processed 278 from management reports menu 276) is to review bills that have been processed and not processed by close month. This section allows a user to understand which bills have been processed and which bills have yet to be processed for a given close month. The bills processed report allows a user to review which bills have been processed in the current close month.

Trending M2: Recurring charge trend analysis (accessed by selecting trending 280 from management reports menu 276) consists of a drill down analysis performed by vendor and billed account number (BAN). A drill down analysis is then performed under each vendor having a variety of account numbers that correspond to subsets of billing (e.g., there can be a bill for each central office of the vendor in each state). Thus, the drill down is done by analyzing each BAN over time by drilling down by vendor and then by BAN. The trend analysis identifies the largest variances from the trend, i.e., the cost variance from prior months). Drill down isolates BAN's where problems may exist as indicated by excessive variance.

System 10 provides four reports: trending by vendor, by account, by invoice and by cost center. Each report shows one-time payments, recurring payments, and total payments on a month-by-month basis. Anomalies can be verified that are the result of rate and/or quantity exceptions.

Period Expenses M3: This procedure provides reports to understand current period expense by vendor, market and product. Access to the procedure is by selecting accounting 282 from the management report menu 276 to access accounting menu 288 from which period expenses 290 is selected. This procedure is for management reporting purposes and reconciling to the general ledger. The expense summary report is broken down by vendor, market and product. The vendor report summarizes period expense by vendor, the market report summarizes period expense by market, and the product report summarizes period expense by product. Each of the reports indicates the product, type, circuit, billed expense, accrued expense, previous accrued expense and pre-paid expense.

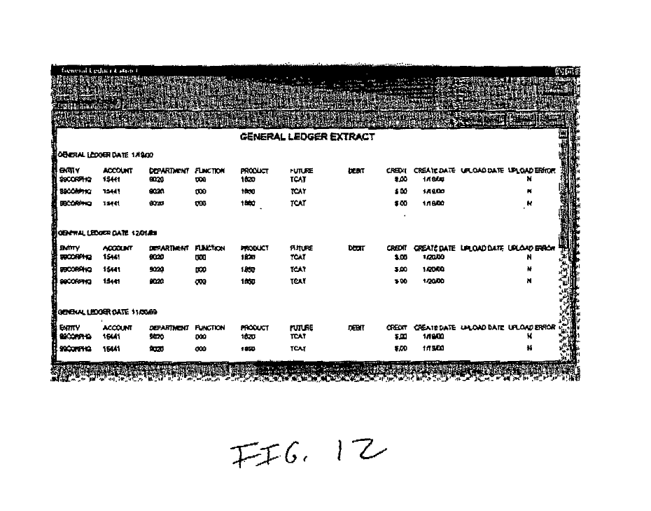

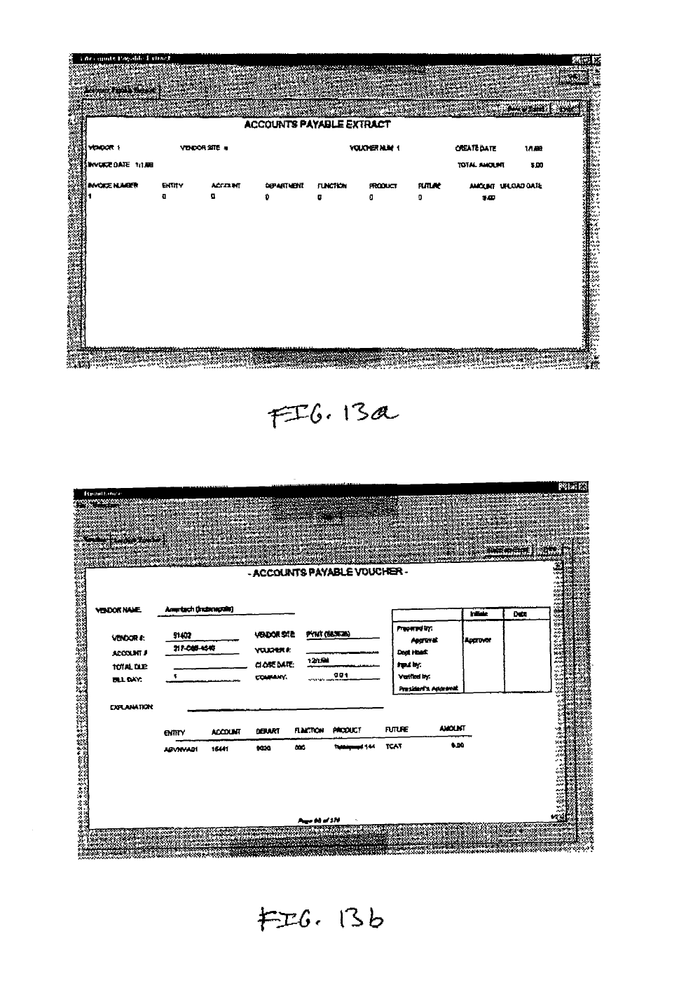

Preparing Accruals M4: This procedure allows a user to review circuit accruals, adjust them as necessary and transmits them to the general ledger interface. Access to this procedure is from accounting menu 288. Selecting accrual detail 294 provides access to the accrual detail screen, which shows the delivery date, type, accrual start date, accrued expense, capital expense and status for each circuit ID. From the accrual detail screen the information may be printed, saved to a spreadsheet or submitted as an extract to the general ledger (G/L). Selecting accrual summary 296 provides a summary view of the information from the summary detail. The accruals are derived automatically by system 10 by selecting derive accruals 298. This procedure is required before accruals are sent to the general ledger. System 10 derives the accruals and presents to the user pertinent accrual information. System 10 then provides for the automated submission of the G/L extract, an example of which is depicted in FIG. 12.

Prepare Disputes M5: This procedure provides reports to prepare and submit disputes to vendors. Selecting disputes 284 from the management reports menu to access disputes menu 300 from which form 306 is selected provides access to the procedure. This report is the universal dispute form (as depicted in FIG. 10) and may be saved to an excel spreadsheet or printed for appropriate distribution.

Dispute Tracking M6: This procedure (accessed by selecting history 302 and summary 304 from disputes menu 300) provides reports to track disputes, which have been submitted to vendors and enter updated dispute comments and status as appropriate. History 302 provides historical dispute information tracking back on a month by month basis. Dispute summary report (summary 304) is current dispute information provided by vendor and close-month.

Prepaid Expenses M7: This procedure (accessed by selecting pre-paid expenses 292 from accounting menu 288) provides reports to understand prepaid expenses for the current close month. This report acts as a close report for accounting to reclassify prepaid expenses to operating expenses in the subsequent month. The user can print this report or save it to excel and give a copy to accounting to act as a control for reclassifying prepaid expenses in the subsequent month.

Inventory Reconciliation M8: This procedure (accessed by selecting circuit summary 286 from management reports menu 276) provides reports to determine how many circuits in inventory have been billed and not billed in the current close month at a summary level by vendor. This allows billing reconciliation management to understand circuit matches between OSS inventory and bills processed through the program by providing information such as the total number of circuits, disconnects (prior period and current period), canceled circuits, circuits in service and billed circuits. This report contains a complete inventory reconciliation summary for the current close period by comparing OSS inventory counts by vendor with billed counts.

System Processing Statistics M9: This procedure (accessed by pressing a specific Alt key sequence from main menu 200) provides reports to view processing statistics for system processes (e.g., bill processing, inventory loading, etc.) and is an optional procedure. The processing statistics reveal critical information about jobs recently processed including BAN, Bill Date (if it is a CABS job), # of Records Processed, the Job #, the Start Date/Time and the Duration in minutes.

### DATA TABLE MAINTENANCE

Selecting maintenance 220 from main menu 200 leads to data table maintenance menu 278 from which procedures MNT1 through MNT4 are executed. On maintenance menu 278 options are provided for archiving 310 (procedure MNT1), tariff and contract 312 (procedure MNT2), accounting codes 314 (procedure MNT3) and USOC logic sets 316 (procedure MNT4).

Archiving MNT1: This procedure archives all data from the current close month and updates the close month to the next month.

Tariff And Contract Rates MNT2: This procedure maintains tariff and contract rates in system 10. Tariff and contract rates can be added, updated or expired.

Accounting Codes MNT3: This procedure maintains valid accounting codes in the program such that they are identical to those in the general ledger. Codes may relate to accounts, departments, functions, products or future items. Codes can be added and updated.

Universal Service Order Code Logic Sets MNT4: This procedure maintains the Universal Service Order Code Logic Sets. USOC's may be added or updated with information such as the appropriate USOC quantity, whether it is a billed USOC, effective date, expiration date, and whether the USOC is for one-time charges (i.e., appears within OC&C).

### BILL CONFIGURATION

Selecting bill configuration 222 from main menu 200 leads to bill configuration menu 280 from which procedures B1 and B2 are executed by selecting add vendor 320 or update vendor 322, respectively.

New Vendor, New BAN & New BTN B1: This procedure creates a new vendor, BAN (Billed Account Number) or BTN (Billed Telephone Number) in system 10. After selecting add vendor 320, necessary information is added for the vendor, BAN, BTN, circuit definition and template. Vendor information includes information such as vendor number, name, site number, contact, and address. BAN information includes information such as billing cycle, end day, payment method, bill format, effective date, and expiration date. BTN information includes information such as invoice description. Circuit definition information includes information such as circuit ID, type, product, employee, effective date, and expiration date. Template information includes information such as line items, entity, account and definition.

Update Vendor, Update BAN & Update BTN B2: This procedure updates information regarding a vendor, BAN or BTN in the program. After selecting update vendor 322, either a vendor, BAN or BTN can be updated.

The foregoing discussion discloses and describes merely exemplary methods and embodiments of the present invention. One skilled in the art will readily recognize from such discussion that various changes, modifications and variations may be made therein without departing from the spirit and scope of the invention. Accordingly, disclosure of the present invention is intended to be illustrative, but not limiting, of the scope of the invention, which is set forth in the following claims and their legal equivalents.

We claim:

1. A data processing system for analyzing billing indices regarding billed telecommunications items comprising:
data input means for receiving the telecommunications bills;
means for storing a database of pre-determined billing indices;
a processor including:
means for comparing the billed indices from the telecommunications bill against of the pre-determined indices,
means for identifying billing discrepancies between the billed indices and the pre-determined indices, and
means for generating deprovision requests and billing disputes based upon the billing discrepancies; and
data output means for transmitting the deprovision requests and the billing disputes.

2. The system recited in claim 1, wherein the processor further includes means for determining and correcting errors in the database of pre-determined billing indices.

3. The system recited in claim 1, wherein the processor further includes means for identifying installed telecommunication components that are not included as the billed telecommunication items and for accruing the un-included installed telecommunication components.

4. A method for analyzing billing items in telecommunications bills received by a consumer from a vendor, comprising the steps of:
extracting data from the telecommunication bills;
identifying non-existent billing item components in the telecommunication bills by comparing the billing item components in the telecommunication bills to an existing component database;
determining erroneous billing item rates in the telecommunication bills by comparing the billing item rates in the telecommunication bills to rate data stored in a rate database;
determining erroneous billing item quantities in the telecommunications bills by comparing the billing item quantities in the telecommunication bills to quantity data stored in a quantity database;
generating a billing dispute for the billing items based upon the non-existent billing item components, erroneous billing item rates and erroneous billing item quantities.

5. The method recited in claim 4 further comprising the steps of:
generating deprovision requests to the vendors based upon the non-existent billing item components.

6. The method recited in claim 4 further comprising the steps of:
determining and correcting errors in the existing component database.

7. The method recited in claim 4 further comprising the steps of:
identifying installed component s from the existing component database that are not included as billing item components in the telecommunication bills; and
accruing the un-included installed components.

8. The method recited in claim 4 where in the quantity database contains component usage and component configuration data.

9. A system for analyzing billing item s in telecommunications bills received by a consumer from a vendor, comprising the steps of:
a existing component database containing data identifying existing components;
a rate database containing data identifying billing rates for the existing components;
a quantity database containing data identifying quantities of the existing components;
means for receiving and extracting data from the telecommunication bills;
means for comparing the billing item components in the telecommunication bills to the existing component database to identify non-existent billing item components in the telecommunication bills;
means for comparing the billing item rates in the telecommunication bills to the rate database to determine erroneous billing item rates in the telecommunication bills;
means for comparing the billing item quantities in the telecommunication bills to the quantity database to determine erroneous billing item quantities in the telecommunications bills;
means for disputing the billing items based upon the non-existent billing item components, erroneous billing item rates and erroneous billing item quantities.

10. The system recited in claim 9 further comprising:
means for generating deprovision requests to the vendors based upon the non-existent billing item components.

11. The system recited in claim 9 further comprising:
means for determining and correcting errors in the existing component database.

12. The system recited in claim 9 further comprising:
means for identifying installed components from the existing component database that are not included as billing item components in the telecommunication bills; and
means for accruing the un-included installed components in an accounting system of the consumer.

13. The system recited in claim 9 wherein the quantity database contains component usage and component configuration data.
